(19) United States
(12) Patent Application Publication
(10) Pub. No.: US 2011/0147030 A1
(43) Pub. Date: Jun. 23, 2011

(54) Handheld machine tool

(76) Inventors: Jens BLUM, Filderstadt (DE); Dietmar Saur, Gomaringen (DE); Tobias Herr, Stuttgart (DE)

(21) Appl. No.: 12/969,902

(22) Filed: Dec. 16, 2010

(30) Foreign Application Priority Data
Dec. 18, 2009 (DE) 10 2009 054 928.5
Jul. 13, 2010 (DE) 10 2010 031 274.6

(51) Int. Cl. B25F 5/00

(52) U.S. Cl. 173/216; 173/217

(57) ABSTRACT

A handheld machine tool, in particular a battery-driven handheld machine tool, having a gear unit and a cooling air unit. The cooling air unit is provided to route a flow of cooling air for cooling the gear unit past at least one gear element of the gear unit.

### RELATED APPLICATION INFORMATION

The present application claims priority to and the benefit of German patent application no. 10 2009 054 928.5, which was filed in Germany on Dec. 18, 2009, and of German patent application no. 10 2010 031 274.6, which was filed in Germany on Jul. 13, 2010, the disclosures of which are incorporated herein by reference.

### FIELD OF THE INVENTION

The present invention relates to a handheld machine tool, in particular a battery-driven handheld machine tool, having a gear unit and a cooling air unit.

### BACKGROUND INFORMATION

Handheld machine tools having a gear unit and a cooling air unit are already known. The cooling air unit is provided in order to produce a flow of cooling air in order to cool an electromotor unit.

### SUMMARY OF THE INVENTION

The exemplary embodiments and/or exemplary methods of the present invention are based on a handheld machine tool, in particular a battery-driven handheld machine tool, equipped with a gear unit and a cooling air unit.

It is proposed that the cooling air unit is provided in order to route a flow of cooling air past at least one gear element of the gear unit for the purpose of cooling the gear unit. In this context, “provided”, in particular, means specially equipped and/or specially designed. The term “gear unit” in this instance specifically defines a mechanism which includes at least two components, in particular gear elements, which are provided in order to jointly modify an amount of a force, a torque and/or a rotational speed, and/or with whose aid a type of motion such as a rotation is able to be converted into a different type of motion, such as a translation. The components, especially the gear elements, may be implemented as toothed wheels and/or as shafts and/or as gearbox covers and/or as gearbox casings. In this context, “gearbox casing” is to be understood in particular as a casing that is provided for the purpose of accommodating gear elements and which is essentially enclosed by a handheld machine tool housing, especially in a shared plane, which essentially extends perpendicular to an axis of rotation of a tool holder of the handheld machine tool and/or to an axis of rotation of a gear element disposed inside the gear unit housing. In this instance, “cooling air unit” specifically denotes a unit that has at least one component, the component generating the flow of cooling air, for example, especially by generating a vacuum pressure, by which air for cooling purposes is aspirated through openings.

The expression “to route past at least one gear element of the gear unit” in this instance, in particular, is meant to define a routing of the stream of cooling air, in which the flow of cooling air directly adjoins at least one wall of the gear element, so that a heat transfer, via convection, is able to take place between the flow of cooling air and the gear element. The wall of the gear element may be realized by an outer wall of the gear element and/or by an inner wall of a cooling air channel disposed inside the gear element. The handheld machine tool according to the present invention may be implemented as a battery-driven, handheld machine tool, in particular one realized as battery-driven screw driller or battery-driven impact drill. The development of the handheld machine tool according to the present invention makes it possible to achieve cooling of the gear element and, via the gear element, advantageous cooling of the entire gear unit by the cooling air unit, in an uncomplicated manner in terms of construction. Furthermore, by cooling the gear unit, the service life of the gear unit is able to be increased in an especially advantageous manner since overheating of the gear unit, in particular of the cooled gear element, is able to be prevented in an advantageous manner.

The gear element may be developed as gearbox cover. In this context, the term “gearbox cover” is to specifically denote a component of the gear unit, which may be disposed in removable manner on the gear unit, especially a gearbox casing, by a screw connection, and which is provided in order to prevent the leakage of lubricant from the gear unit in conjunction with a seal. However, it is conceivable that the gearbox cover is mounted on the gear unit in some other removable manner via connection types previously known to one skilled in the art. During operation of the handheld machine tool, heated lubricant transmits heat from the gearbox to the gear unit cover, so that the design of the gear element as gearbox cover according to the present invention is especially advantageous because it makes it possible to dissipate heat from the gear unit.

Furthermore, it is proposed to realize the gear element as annulus gear of the gear unit implemented as planetary gear. The gear unit may be developed as multi-stage planetary gear. By switching between planetary gear stages of the gear unit, a step-down or a step-up ratio of a rotary speed and/or a torque produced by an electromotor unit of the handheld machine tool is therefore able to be achieved in an advantageous manner. In addition, it especially may be that if the gear element is implemented as annulus gear of a first planetary gear stage. The annulus gear of the first planetary gear stage is disposed along a main extension direction, which extends from a handle of the handheld machine tool in the direction of a tool holder of the handheld machine tool, downstream from the electromotor unit, especially downstream from the gearbox cover of the gear unit. However, it is also conceivable that the annulus gear is integrally formed with the gearbox cover. The term “integrally formed” in this instance specifically means constructed in one piece and/or formed from one cast and/or implemented as one component, which is able to be separated only by using a separation and/or cutting tool. The main extension direction essentially runs parallel to an axis of rotation of a tool holder of the handheld machine tool and/or to an axis of rotation of the gear element of the gear unit. In this instance, the expression “essentially parallel” specifically defines a direction which features a deviation of especially less than 8°, advantageously less than 5°, and especially advantageously, less than 2° relative to a reference direction. With the aid of the development of the gear element as annulus gear according to the present invention, a compact design and advantageous cooling of the gear unit are able to be achieved.

The handheld machine tool advantageously includes an electromotor unit, which has at least one shaft and at least one bearing support element for supporting a bearing of the shaft of the electromotor unit. In an especially particular manner, the bearing support element may be at least partially formed in one piece with the gear element. In one especially particular development of the handheld machine tool according to the present invention, the gear element is produced from a sintered material. Furthermore, in an alternative development of the handheld machine tool according to the present invention, it is proposed that the gear element is made from a zinc alloy. However, it is also conceivable that the bearing support element is formed by a component that is separate from the gear element. Different material combinations, which have a positive effect on an advantageous heat transfer, are conceivable for this purpose. In a gear element made from sintered material, the bearing support element may likewise be made from sintered material, or the bearing support element is made from an aluminum or a magnesium or a zinc alloy. In a gear element made from plastic, the bearing support element may also be produced from sintered material, or the bearing support element is made from an aluminum or a magnesium or a zinc alloy. Furthermore, in one additional development of the gear element, especially a gearbox cover, made from plastic, it is also conceivable that a heat-conducting element implemented as a drawn sheet metal part may be inserted into the gear element to dissipate heat. The heat-conducting element implemented as drawn sheet metal part may be situated along the axis of rotation of the tool holder of the handheld machine tool, and/or along the axis of rotation of a gear element, especially a toothed wheel, of the gear unit, between the gear element, especially a gearbox cover, and planetary wheels of the gear unit.

The bearing support element and/or the heat-conducting element implemented as drawn sheet metal part may advantageously serve as heat store or heat conductor, so that in the case of an integral development of the bearing support element and the gear element, or in the case of one of the aforementioned combinations of material types, an advantageous heat transfer away from the gear unit is able to be achieved in a separate implementation of the bearing support element and the gear element. Furthermore, through the development according to the present invention, cooling of the gear element, especially cooling of the entire gear unit, by approximately 20° C. is achievable in an especially advantageous manner, so that a service life of the gear element and a lubricant provided in the gear unit is able to be increased in an especially advantageous manner.

In addition, it is proposed that the handheld machine tool includes an electromotor unit, which has a fan wheel, which is at least partially formed in one piece with a fan wheel of the cooling air unit so as to generate the flow of cooling air for cooling the gear unit. In an especially particular manner, 20% of the entire flow of cooling air is used for cooling the gear unit, and 80% of the entire flow of cooling air is used for cooling the electromotor unit. With the integral formation of the fan wheel of the electromotor unit with the fan wheel of the cooling air unit, further components for cooling the gear unit are able to be dispensed with, which advantageously saves space, expense and installation outlay.

The handheld machine tool according to the present invention may include an electromotor unit, which has at least one rotor, the cooling air unit having at least one cooling air channel, which routes the flow of cooling air along a main extension direction between the rotor and the gear element. The term “cooling air channel” is meant to specifically denote a system and/or a construction method of components that is provided for the selective routing of the cooling-air flow. It is conceivable to place an air-conducting arrangement, such as air guide vanes, in particular, in the cooling air channel, which may be provided for the selective routing of the flow of cooling air and/or for generating turbulence in the flow of cooling air so as to produce a turbulent flow. This also makes it possible to selectively route the flow of cooling air to a heat source for the dissipation of heat, and/or to selectively route it past the heat source in an uncomplicated manner in terms of construction, so that a heat transfer by convection is advantageously able to take place. Thus, overheating of components is able to be counteracted in an advantageous manner.

In one exemplary development, the handheld machine tool has a handheld machine tool housing provided with at least one intake opening for cooling air, which is at least partially formed in one piece with the cooling air channel. The term “handheld machine tool housing” specifically is meant to define an outermost casing that encloses components of the handheld machine tool, so that the components of the handheld machine tool are essentially protected from external influences, the casing being provided to allow an operator of the handheld machine tool to handle and operate, especially guide, the handheld machine tool. The handheld machine tool housing may be made of a unit that encompasses at least two housing half-shells, which are joinable along a connection plane. The handheld machine tool housing may be made from a variety of materials that are deemed practical by the expert, such as a metal, a nonferrous metal etc., which may be from plastic. Using the configuration according to the exemplary embodiments and/or exemplary methods of the present invention, it is possible to use ambient air for the cooling, in particular for the cooling of the gear unit, in a simple manner in terms of construction.

In addition, it is proposed that the gear element is disposed along the main extension direction at least partially between a pinion situated on a shaft of the electromotor unit, and the rotor of the electromotor unit. In this context, “between” is meant to denote a spatial position of a component, in particular the gear element, between other components, especially the pinion and the rotor of the electromotor unit.

This advantageously makes it possible to use the flow of cooling air to cool the gear unit, in particular the gear element, and simultaneously to cool the rotor of the electromotor unit. Additional components for cooling the rotor are advantageously able to be dispensed with.

Further advantages are derived from the description of the figures that follows. The drawing shows exemplary embodiments of the present invention. The drawing, the description, and the claims include numerous features in combination. One skilled in the art will necessarily consider the features also individually and combine them into useful further combinations.

### BRIEF DESCRIPTION OF THE DRAWINGS

FIG. 1 shows a handheld machine tool according to the present invention, in a schematized illustration.

FIG. 2 shows a detail view of the handheld machine tool according to the present invention, showing an open handheld machine tool housing in a schematized illustration.

FIG. 3 shows a detail view of the handheld machine tool according to the present invention, showing an open handheld machine tool housing in a schematized illustration.

FIG. 4 shows a detail view of another, alternative handheld machine tool according to the present invention, showing an open handheld machine tool housing in a schematized illustration.

### DETAILED DESCRIPTION

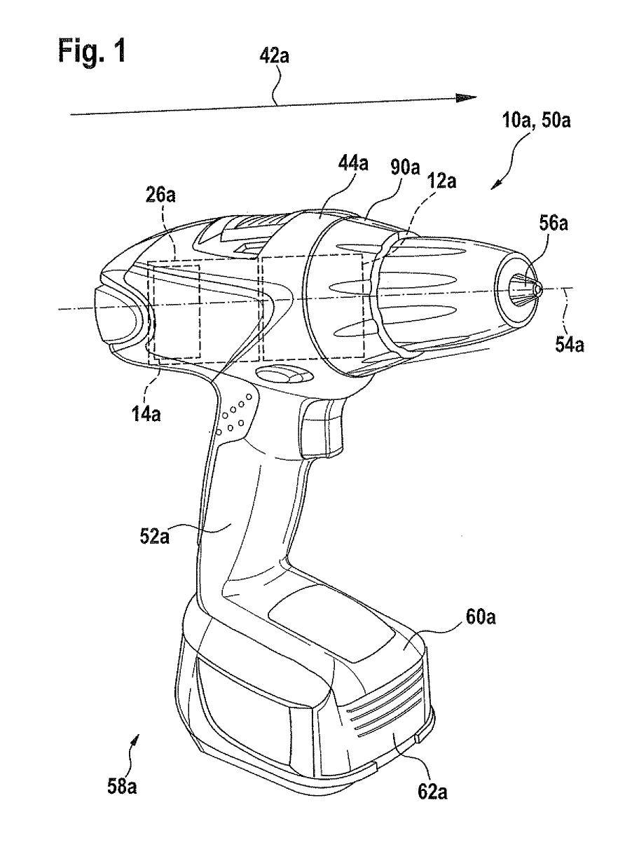

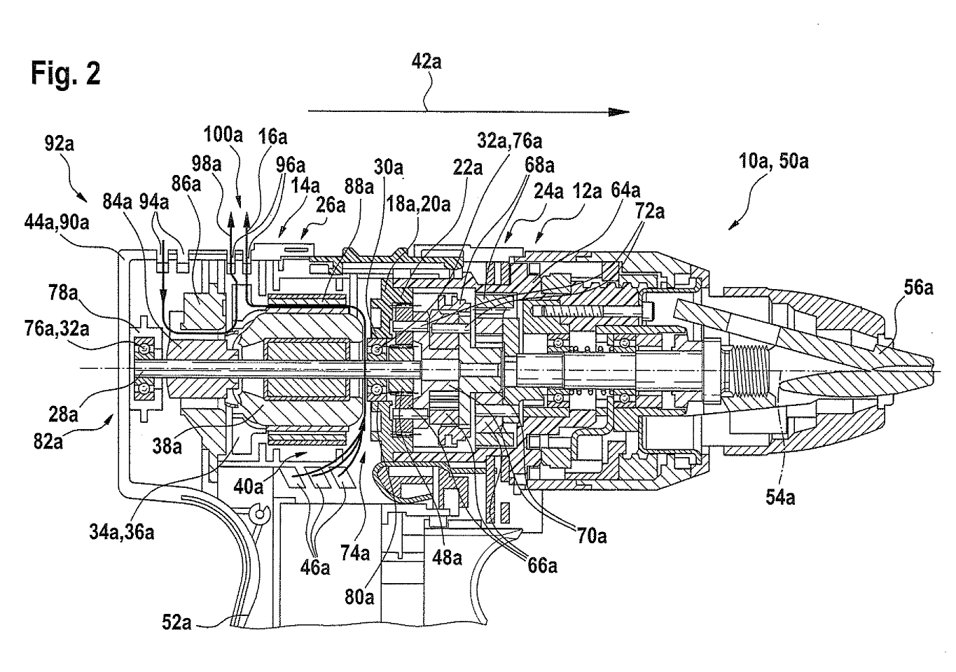

FIG. 1 shows a schematized illustration of a handheld machine tool 10a according to the present invention, which is implemented as battery-driven drill screwer 50a. Handheld machine tool 10a includes a gear unit 12a and a cooling air unit 14a. Cooling air unit 14a is provided in order to route a first flow of cooling air 16a for cooling gear unit 12a past a gear element 18a of gear unit 12a while handheld machine tool 10a is in operation (FIG. 2). Gear unit 12a is connected to an electromotor unit 26a of handheld machine tool 10a for the generation of a torque and/or a rotational speed. The generation of the torque and/or the rotational speed with the aid of gear unit 12a and electromotor unit 26a takes place in a manner that is already known to the expert, so that no detailed description will be provided here. Furthermore, handheld machine tool 10a includes a handheld machine tool housing 44a and a handle 52a, which extends perpendicular to a main extension direction 42a of handheld machine tool 10a. Main extension direction 42a extends parallel to an axis of rotation 54a of a tool holder 56a of handheld machine tool 10a provided for the purpose of accommodating a tool (not shown here). Handle 52a includes an accumulator receptacle 60a on a side 58a facing away from handheld machine tool 10a. Accumulator receptacle 60a is provided for holding an accumulator unit 62a for the energy supply of handheld machine tool 10a.

FIG. 2 shows a detail view of handheld machine tool 10a according to the exemplary embodiments and/or exemplary methods of the present invention, featuring an open handheld machine tool housing 44a in a schematized illustration. Handheld machine tool 10a includes a gearbox casing 64a, which is disposed inside handheld machine tool housing 44a. Gearbox casing 64a is sealed with the aid of gear element 18a, which is implemented as gearbox cover 20a. Gearbox casing 64a is provided in order to accommodate components of gear unit 12a and to support them. Gear unit 12a is developed as multi-stage planetary gear 24a. Thus, planetary wheels 66a, annulus gears 22a, 68a, a sun gear implemented as pinion 48a, or planetary supports 70a integrally formed with sun gears, and shafts 72a of planetary gear 24a are supported inside gearbox casing 64a. A method of functioning of gear unit 12a implemented as planetary gear 24a is already known to the expert, so that no further description will be provided here. In one exemplary development of handheld machine tool 10a according to the present invention, gear element 18a is implemented as annulus gear 22 of gear unit 12a developed as planetary gear 24a. Annulus gear 22a is integrally formed with gearbox cover 20a. Annulus gear 22a integrally formed with gearbox cover 20a constitutes annulus gear 22a of a first planetary gear stage of gear unit 12a implemented as planetary gear 24a. To reduce wear and friction in planetary gear 24a, a lubricant in the form of lubricating grease is provided inside gearbox casing 64a.

Electromotor unit 26a is disposed inside handheld machine tool housing 44a on a side 74a of gearbox casing 64a that is facing away from tool holder 56a. Electromotor unit 26a has a shaft 28a, which is supported in handheld machine tool housing 44a via bearings 32a. Bearings 32a are implemented as ball bearings 76a. To accommodate ball bearing 76a, handheld machine tool 10a includes a first bearing support element 30a and a second bearing support element 78a. First bearing support element 30a for accommodating one of ball bearings 76a of shaft 28a of electromotor unit 26a is disposed as axial recess 80a in gearbox cover 20a. Thus, first bearing support element 30a is integrally formed with gear element 18a implemented as gearbox cover 20a. Second bearing support element 78a is disposed in handheld machine tool housing 44a on a side 82a of electromotor unit 26a facing away from tool holder 56a. For the meaningful transmission of heat away from gear unit 12a, gear element 18a integrally formed with bearing support element 30a and annulus gear 22a of the first planetary gear stage and implemented as gearbox cover 20a, is made from sintered material. As an alternative, for the useful transmission of heat away from gear unit 12a, gear element 18a is made from a zinc alloy.

Furthermore, electromotor unit 26a has a rotor 38a, a commutator 84a, a fan wheel 34a, a sliding contact 86a implemented as carbon brushes, and a stator 88a. Rotor 38a, commutator 84a, and fan wheel 34a are mounted on shaft 28a in a torque-proof manner, so that a rotational speed of shaft 28a of electromotor unit 26a corresponds to a rotational speed of rotor 38a, commutator 84a, and fan wheel 34a. Sliding contact 86a implemented as carbon brushes, and stator 88a are supported in torque-proof manner inside handheld machine tool housing 44a. Thus, electromotor unit 26a is implemented as so-called open-frame motor, in which components of electromotor unit 26a are individually supported inside handheld machine tool housing 44a. Gear element 18a implemented as gearbox cover 20a, which is integrally formed with first bearing support element 30a and annulus gear 22a of the first planetary gear stage, is disposed along main extension direction 42a, between pinion 48a positioned on shaft 28a of electromotor unit 26a, and rotor 38a of electromotor unit 26a. Shaft 28a of electromotor unit 26a extends along main extension direction 42a, an end on which pinion 48a is disposed, projecting into gearbox casing 64a. Pinion 48a is in engagement with annulus gear 22a of the first planetary gear stage of gear unit 12a.

Fan wheel 34a of electromotor unit 26a is integrally formed with a fan wheel 36a of cooling air unit 14a in order to produce first flow of cooling air 16a for the cooling of gear unit 12a. In addition, cooling air unit 14a for cooling gear unit 12a has a cooling air channel 40a, which routes first flow of cooling air 16a along main extension direction 42a between rotor 38a of electromotor unit 26a and gear element 18a implemented as gearbox cover 20a, which is integrally formed with first bearing support element 30a and annulus gear 22a of the first planetary gear stage. Thus, first flow of cooling air 16a for cooling gear unit 12a is routed past gear element 18a implemented as gearbox cover 20a perpendicular to main extension direction 42a, which gear element is integrally formed with annulus gear 22a of the first planetary gear stage and first bearing support element 30a. Cooling air channel 40a is integrally formed with a cooling air intake opening 46a of handheld machine tool housing 44a. As an alternative, air routing elements implemented as air guide vanes (not illustrated here) are disposed inside cooling air channel 40a. However, other air routing elements known to the expert may alternatively be provided as well.

Cooling air intake opening 46a is disposed in a region of handheld machine tool housing 44a that is facing handle 52a. Handheld machine tool housing 44a is provided with a total of six cooling air intake openings 46a for first flow of cooling air 16a for the cooling of gear unit 12a, which are integrally formed with cooling air channel 40a. Three cooling air intake openings 46a are situated within a housing half-shell 90a of handheld machine tool housing 44a in each case. On a side 92a of handheld machine tool housing 44a facing away from handle 52a, handheld machine tool housing 44a has additional cooling air intake openings 94a for cooling commutator 84a and sliding contact 86a implemented as carbon brushes.

To cool gear unit 12a, first flow of cooling air 16a is produced with the aid of fan wheel 34a, 36a of cooling air unit 14a, and/or electromotor unit 26a. In the process, using vacuum pressure generated by fan wheel 34e, 36a, ambient air is aspirated through cooling air intake openings 46a of handheld machine tool housing 44a and routed through cooling air channel 40a past gear element 18a, which is implemented as gearbox cover 20a and integrally formed with bearing support element 30a and annulus gear 22a of the first planetary gear stage. In order to cool gear unit 12a, first flow of cooling air 16a flows perpendicular to main extension direction 42a, via shaft 28a and past ball bearing 76a. Via convection, gear element 18a transmits heat from gear unit 12a to first flow of cooling air 16a routed past it, which transports the heat away from gear unit 12a through cooling air discharge openings 96a and out of handheld machine tool housing 44a. In the process, shaft 28a and ball bearing 76a likewise transmit heat to first flow of cooling air 16a, via convection, in order to cool gear unit 12a. Due to the lubricating grease provided inside gearbox casing 64a, a heat equalization takes place inside gearbox casing 64a or inside gear unit 12a, so that the heat from entire gear unit 12a is transmitted to annulus gear 22a of the first planetary gear stage and the heat is dissipated away from gear unit 12a due to the integral implementation of annulus gear 22a of the first planetary gear stage with gear element 18a developed as gearbox cover 20a, via first flow of cooling air 16a.

Furthermore, fan wheel 34a, 36a generates a second flow of cooling air 98a, which is provided for cooling commutator 84a and sliding contact 86a implemented as carbon brushes. Second flow of cooling air 98a is also produced by the vacuum pressure generated with the aid of fan wheel 34a, 36a, which vacuum pressure aspirates ambient air through additional cooling air intake openings 94a of handheld machine tool housing 44a. Second flow of cooling air 98a is routed along main extension direction 42a to provide cooling between commutator 84a and sliding contact 86a implemented as carbon brushes. In the process, via convection, commutator 84a and sliding contact 86a implemented as carbon brushes transmit heat to passing second flow of cooling air 98a, which transports the heat through cooling air discharge openings 96a away from handheld machine tool housing 44a. If first flow of cooling air 16a and second flow of cooling air 98a are added up, then first flow of cooling air 16a and second flow of cooling air 98a form an overall flow of cooling air 100a. First flow of cooling air 16a and second flow of cooling air 98a jointly may be regarded as 100% of overall flow of cooling air 100a. In this context, first flow of cooling air 16a constitutes approximately 20% of overall flow of cooling air 100a, and second flow of cooling air 98a constitutes approximately 80% of the overall flow of cooling air 100a.

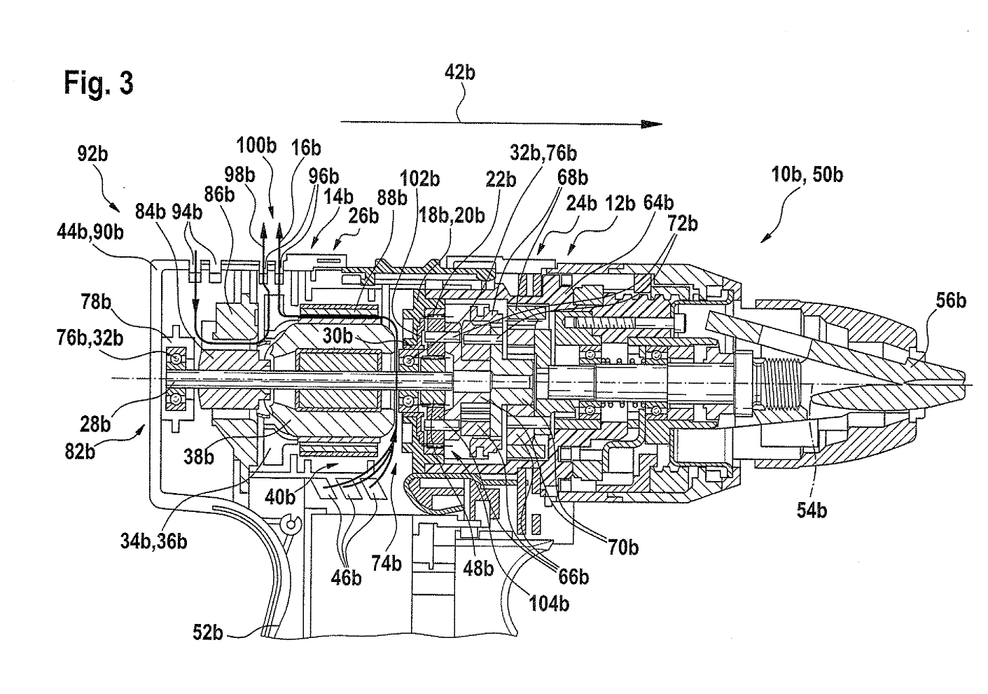

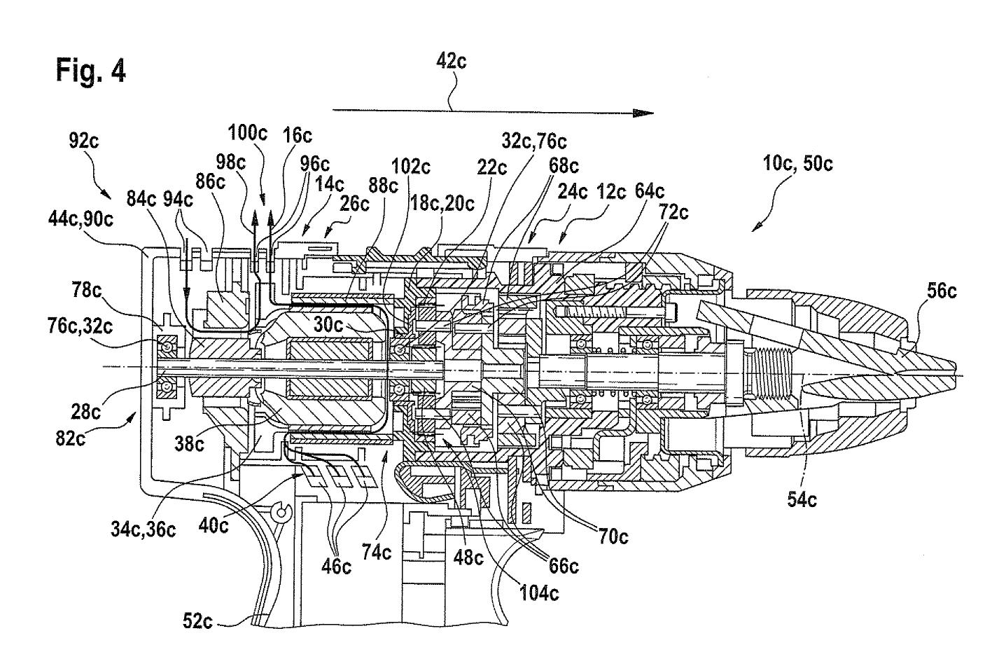

FIGS. 3 and 4 show alternative exemplary embodiments. Essentially unchanged components, features and functions are basically denoted by the same reference numerals. To differentiate the exemplary embodiments, the letters a, b and c have been added to the reference numerals of the exemplary embodiments. The following description is essentially restricted to the differences with respect to the exemplary embodiment in FIG. 2, reference being made to the description of the exemplary embodiment in FIG. 2 with regard to components, features and functions that remain unchanged.

FIG. 3 shows a detail view of an alternative handheld machine tool 10b according to the present invention, with an open handheld machine tool housing 44b in a schematized illustration. Handheld machine tool 10b corresponds to a handheld machine tool 10a shown in FIG. 1. Handheld machine tool 10b includes a gear unit 12b implemented as multi-stage planetary gear 24b, and a cooling air unit 14b. Cooling air unit 14b is provided in order to route a first flow of cooling air 16b for cooling gear unit 12b past a gear element 18b of gear unit 12b while handheld machine tool 10b is in operation. Gear element 18b in handheld machine tool 10b is developed as gearbox cover 20b. Gearbox cover 20b is made from plastic. An alternative annulus gear 22b of a first planetary gear stage of gear unit 12b is formed by a component that is separate from gearbox cover 20b.

Furthermore, handheld machine tool 10b includes a tool holder 56b to accommodate a tool (not illustrated here). Mounted on a side 104b, facing tool holder 56b, of gearbox cover 20b mounted on a gearbox casing 64b is a heat-conducting element 102b. Heat-conducting element 102b is implemented as drawn sheet metal part and adapted to a contour of gearbox cover 20b. Heat-conducting element 102b is inserted into gearbox cover 20b during assembly and is provided in order to transmit, via convection, heat away from gear unit 12b to first flow of cooling air 16b while handheld machine tool 10b is in operation. Toward this end, heat-conducting element 102b is integrally formed with an alternative first bearing support element 30b of a bearing 32b of a shaft 28b of electromotor unit 26b. First bearing support element 30b is sleeve-shaped and extends along a main extension direction 42b, in the direction of electromotor unit 26b. Thus, first flow of cooling air 16b for cooling gear unit 12b is routed directly past first bearing support element 30b and directly past heat-conducting element 102b integrally formed with first bearing support element 30b.

FIG. 4 shows a detail view of an alternative handheld machine tool 10c according to the present invention, with an open handheld machine tool housing 44c in a schematized illustration. Handheld machine tool 10c corresponds to a handheld machine tool 10a shown in FIG. 1. Handheld machine tool 10c includes a gear unit 12c implemented as multi-stage planetary gear 24c, and a cooling air unit 14c. Cooling air unit 14c is provided in order to route a first flow of cooling air 16c for cooling gear unit 12c past a gear element 18c of gear unit 12c while handheld machine tool 10c is in operation. Gear element 18c in handheld machine tool 10c is developed as gearbox cover 20c. Gearbox cover 20c is made from a sintered material. As an alternative, for the practical transmission of heat away from gear unit 12c, gearbox cover 20c is made from a zinc alloy. An annulus gear 22c of a first planetary gear stage of gear unit 12c is formed by a component that is separate from gearbox cover 20c. However, it is also conceivable that annulus gear 22c of the first planetary gear stage is implemented in one piece with gearbox cover 20c.

In addition, handheld machine tool 10c is equipped with an electromotor unit 26c. Electromotor unit 26c is implemented as so-called open-frame motor, in which the components of electromotor unit 26c are individually supported inside handheld machine tool housing 44c. A stator 88c of electromotor unit 26c extends from gearbox cover 20c in the direction of a side 82c of electromotor unit 26c facing away from a tool holder 56c of handheld machine tool 10c. In a mounted state, stator 88c is disposed adjacent to gearbox cover 20c. Stator 88c thus has direct contact with gearbox cover 20c, so that a heat transfer through conduction is able to take place from gearbox cover 20c to stator 88c, away from gear unit 12c. Via first flow of cooling air 16c, heat is carried away from stator 88c and gearbox cover 20c. However, it is also conceivable that electromotor unit 26c is implemented as a so-called can motor, in which all components are disposed inside a metal housing. When electromotor unit 26c is implemented as so-called can motor, the metal housing rests against gearbox cover 20c, so that a heat transfer from gear unit 12c is able to take place.

In addition, handheld machine tool 10c includes a heat-conducting element 102c. Heat-conducting element 102c is implemented as a drawn sheet metal part and adapted to a contour of gearbox cover 20c. Heat-conducting element 102b is provided to transmit heat from gear unit 12c to first flow of cooling air 16c via convection while handheld machine tool 10c is in operation. Toward this end, heat-conducting element 102c is integrally formed with a first bearing support element 30c of a bearing 32c of a shaft 28c of electromotor unit 26c. First flow of cooling air 16c for cooling gear unit 12c is routed directly past first bearing support element 30c and directly past heat-conducting element 102c integrally formed with first bearing support element 30c. However, it is also conceivable that bearing support element 30c and heat-conducting element 102c are implemented in one piece together with gearbox cover 20c.

What is claimed is:

1. A handheld machine tool, which is battery-driven, comprising:
a gear unit; and
a cooling air unit;
wherein the cooling air unit is configured to route a flow of cooling air for cooling the gear unit past at least one gear element of the gear unit.

2. The handheld machine tool of claim 1, wherein the gear element is a gearbox cover.

3. The handheld machine tool of claim 1, wherein the gear element is an annulus gear of the gear unit configured as a planetary gear.

4. The handheld machine tool of claim 1, further comprising:
an electromotor unit, which has at least one shaft and at least one bearing support element for holding a bearing of the shaft of the electromotor unit.

5. The handheld machine tool of claim 4, wherein the bearing support element is configured at least partially in one piece with the gear element.

6. The handheld machine tool of claim 1, wherein the gear element is produced from a sintered material.

7. The handheld machine tool of claim 1, wherein the gear element is produced from a zinc alloy.

8. The handheld machine tool of claim 1, further comprising:
an electromotor unit, which includes a fan wheel, which is at least partially integrally formed with a fan wheel of the cooling air unit to generate the flow of cooling air for cooling the gear unit.

9. The handheld machine tool of claim 1, further comprising:
an electromotor unit, which includes at least one rotor, the cooling air unit having at least one cooling air channel, which routes the flow of cooling air along a main extension direction between the rotor and the gear element.

10. The handheld machine tool of claim 9, further comprising:
a handheld machine tool housing, which has at least one cooling air intake opening, which is at least partially formed integrally with the cooling air channel.

11. The handheld machine tool of claim 9, wherein the gear element is disposed along the main extension direction at least partially between a pinion disposed on a shaft of the electromotor unit, and the rotor of the electromotor unit.
